(19) United States
(12) Patent Application Publication
(10) Pub. No.: US 2021/0172547 A1
(43) Pub. Date: Jun. 10, 2021

(54) MULTI PART PLASTIC ASSEMBLY THAT SIMPLIFIES THE APPLICATION OF PRIMER SOLVENTS AND PLASTIC BONDING CEMENTS AND/OR AGENTS TO PLASTIC AND/OR PVC PIPING

(71) Applicant: Michael Dale MCGEE, Lake Havasu City, AZ (US)

(72) Inventor: Michael Dale MCGEE, Lake Havasu City, AZ (US)

(21) Appl. No.: 16/706,728

(22) Filed: Dec. 7, 2019

(51) Int. Cl. F16L 13/10; F16L 15/06

(52) U.S. Cl. CPC F16L 13/106; F16L 13/103; F16L 15/06

(57) ABSTRACT

The present invention is a system and methods that facilitates the application of PVC primer (solvent) or PVC glue to the inner surfaces of PVC unions and the outer surface of PVC pipes. The invention consists of a PVC primer (solvent) or PVC glue reservoir, a method of pressurizing the reservoir, and forcing the PVC primer (solvent) or PVC glue through a series of tubes and holes in the apparatus and into a foam applicator which transfers the PVC primer (solvent) or PVC glue onto the inner surface or onto the outer surface of a PVC union or PVC pipe to a predetermined depth thus reducing waste of the PVC primer (solvent) or PVC glue. The foam application housing contains a foam applicator specifically for applying PVC primer (solvent) or PVC glue to either the inner surface of a PCV union or to the outer surface of a PVC pipe giving a uniform application of PVC primer (solvent) or PVC glue.

### FIELD OF INVENTION

The field of invention relates to devices that dispense primer solvent and plastic cement solutions onto and into plastic and/or PVC tubing in residential and commercial construction.

### BACKGROUND

New construction of residences and commercial structures more and more are using plastic and PVC piping for both interior and exterior applications. Typical application of both primer solvents and plastic cement solution onto the interior of plastic and PVC union connections and onto the exterior surface of plastic and PVC pipes generally results in either too little or too much primer solvents and too little or too much plastic cement.

The result of over application of primer solvents to the interior surfaces of unions and angled joints can cause roughening of the portion of the union or joint allowing particle matter traveling through the finished piping a surface to catch onto resulting in bacteria and algae growth. The under application of primer solvents to the interior surfaces of unions and angled joints can result in a weak bond when a plastic or PVC pipe coated on the exterior portion of the pipe coated with plastic cement is inserted into the joint union. If the interior surface of the union is not properly prepared with a solvent primer, the plastic cement on the surface of the inserted plastic or PVC pipe may not properly bond with the interior surface of the union. This may result in a failed joint when the pipe assembly is put under pressure.

The result of over application of the plastic cement results in plastic cement buildup inside the end of the plastic or PVC pipe where it is inserted into the union. This buildup of plastic cement may result in microparticles of the cement breaking off the buildup and flowing away in the liquid stream passing through the pipe. If the liquid stream inside the pipe is water and is providing drinking water to people ingesting the water, the microparticles of the plastic pipe may be harmful to their health. Under application of plastic cement to the exterior of the plastic or PVC pipe the surface area of the bonding region between the pipe and the union is diminished. This may result in a failed joint when the pipe assembly is put under pressure.

### Problem Statement

What is needed is some device or system to guarantee the application of primer and plastic cement to the exterior surface of the pipe and the interior surface of the union without over or under application of the primer or the cement thus facilitating a more perfect joining of the pipe and union.

### SUMMARY

The instant invention discloses a number of devices and systems to alleviate most or all of the problems if installing plastic or PVC thin and heavy walled piping by simplifying the process of applying priming solutions and cements or other bonding solutions to making a joining of the pipes permanent.

### Embodiments

Reference will now be made in detail to various embodiments, examples of which are illustrated in the accompanying drawings. Wherever possible, the same reference numbers will be used throughout the drawings to refer to the same or like parts.

### Definitions

Primer Solvent: The purpose of primer is to begin the chemical reaction that softens PVC and to provide an even prepped surface for the solvent cement.

Plastic Cement: PVC Cement is a solvent. The way to connect PVC pipe and unions is through solvent welding.

### BRIEF DESCRIPTION OF THE FIGURES

FIG. 1 is an exploded view of the apparatus making up the invention.

FIG. 2 is a depiction of the interior components comprising the invention.

FIG. 3 is a cross sectional view of solvent/glue and foam containment object 18.

FIG. 4 is a cross sectional view of solvent/glue and foam containment object 12.

### EMBODIMENTS

Reference will now be made in detail to various embodiments, examples of which are illustrated in the accompanying drawings. Wherever possible, the same reference numbers will be used throughout the drawings to refer to the same or like parts.

In a first exemplary embodiment, an apparatus assembly and system are disclosed where PVC primer (solvent) or PVC glue is applied to the outer surface of the area of a PVC pipe that will be inserted into a union. The outer surface area of the PVC pipe to receive the PVC primer or PVC glue is limited to that portion of the outer end of the pipe that will be received into the union.

In a related embodiment the apparatus and system are alterable such that the application surface component of the invention may be changed such that the application surface may apply PVC primer (solvent) or PVC glue to the inner surface of a PCV union or to the outer surface of a PVC pipe.

In a second exemplary embodiment, a portion of the apparatus that dispenses PVC solvent or PVC glue is removable and replaceable to accommodate different inside diameters of unions and outside diameters of PVC pipe.

### DETAILED DESCRIPTION OF THE INVENTION

Objects and advantages of the present invention will become apparent to those skilled in the art upon reading this description in conjunction with the accompanying drawings, in which like reference numerals have been used to designate like or analogous elements.

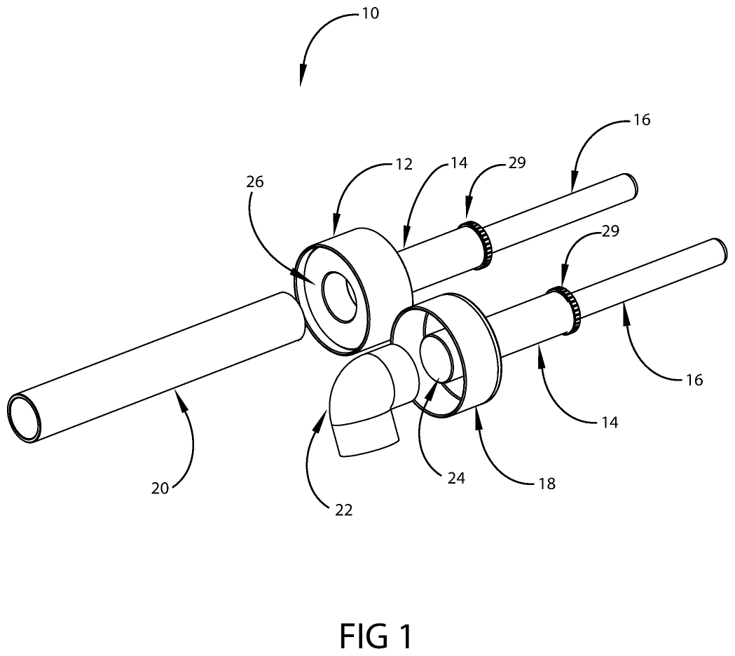

Now referencing FIG. 1 where 10 depicts an exterior exploded view of the assembly comprising the invention. In this figure, foam insert 26 and 24 are contained within foam applicator housing 12 where foam inserts 26 and 24 receive PVC primer (solvent) or PVC glue from reservoir 14. Foam insert 26 contains a hole in the center of the foam insert. The inside diameter of the hole in foam insert 26 is the same as the outside diameter of pipe 20 and the depth of the hole in foam insert 26 is the depth that pipe 20 is inserted into a union connection such as union 22. When foam insert 26 is saturated with PVC primer (solvent) or PVC glue from reservoir 14, pipe 20, once inserted into the hole of foam insert 26, be covered with a minimal amount of PVC primer (solvent) or PVC glue to the depth of the hole.

Reservoir 14 is comprised of a hollow pipe with one end fixed to foam applicator housing 12 and the other end comprises a threaded end supporting locking nut 29 which retains push rod 16 inside of reservoir 14.

Once locking nut 29 is unscrewed from reservoir 14 by the user, pushing rod 16 and locking nut 29 can be removed exposing the interior of reservoir 14 allowing the user to fill reservoir 14 with PVC primer (solvent) or PVC glue or pour excess or unused PVC primer (solvent) or PVC glue back into a container. Once the user fills reservoir 14 with a sufficient amount of PVC primer (solvent) or PVC glue, pushing rod 16 is reinserted into the open end of reservoir 14 and locking nut 29 is screwed onto the threaded end of reservoir 14 thus sealing reservoir 14 and allowing the user to push pushing rod 16 into reservoir 14 forcing the PVC primer (solvent) or PVC glue unto foam inserts 26 and 24 residing in foam applicator housing 12.

The pushing by the user on pushing rod 16 forces PVC primer (solvent) or PVC glue contained in reservoir 14 through a plurality of holes 40 (not shown) in FIG. 1 and into foam inserts 26 and 24 saturating foam insert 26 and 24 with plastic glue or solvent.

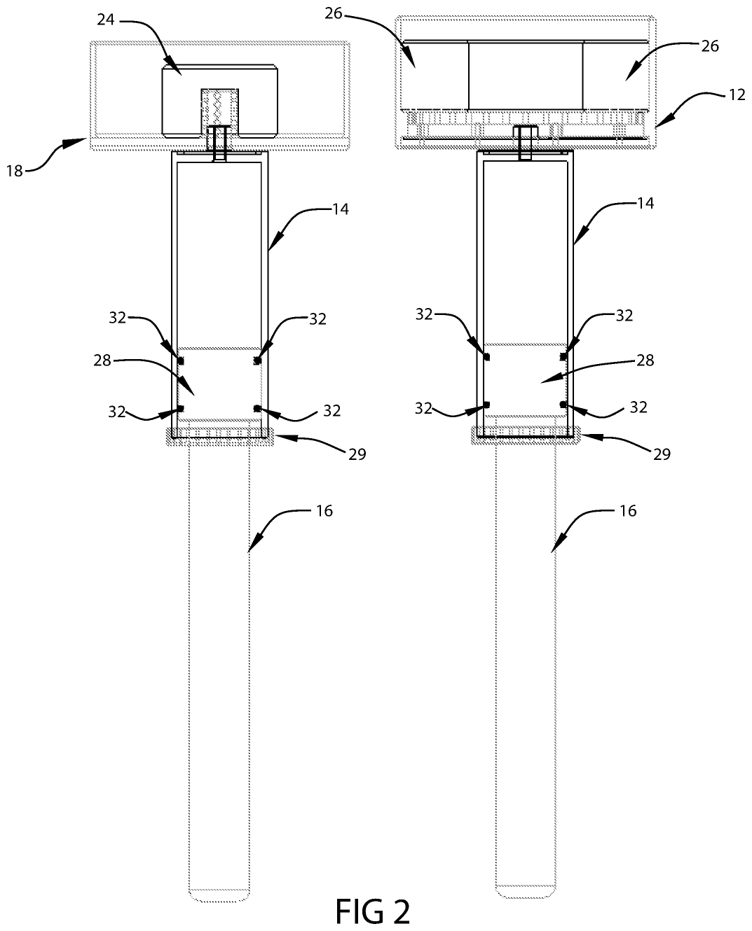

Now referencing FIG. 2 where 50 depicts cross sectional views of the interior components of the invention. In this depiction, pushing rod 14 is fastened to sealing component 28. The outer diameter of sealing component 28 is the same dimension as the inter dimension of reservoir 14 less a clearance dimension which allows sealing component 28 to move up and down in reservoir 14 without binding. Sealing component 28 contains two “O” rings 32 which prevents PVC primer (solvent) or PVC glue from leaking out of reservoir 14 when the user applies pressure to reservoir 14 by pressing against the bottom of pushing rod 16.

Porous foam applicator housing 12 contains porous foam insert 26 which applies PVC primer (solvent) or PVC glue to the outer surface of pipe 20. Porous foam applicator housing 18 contains porous foam insert 24 which applies PVC primer (solvent) or PVC glue to the inner surface of joint union 22.

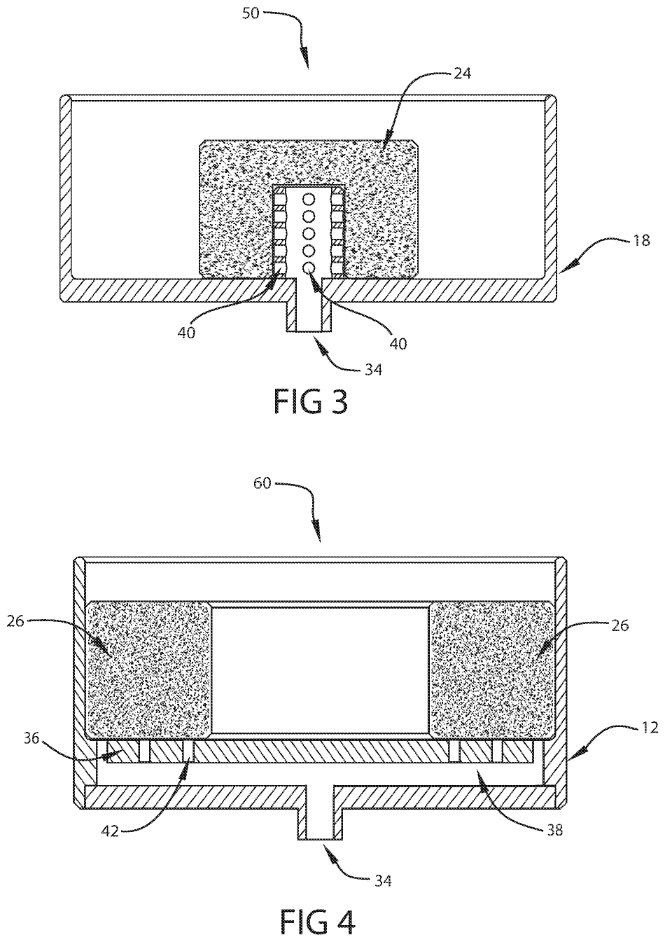

Now referencing FIG. 3 where 50 depicts a cut away view of porous foam applicator housing 18. In this depiction, foam applicator 24 sits on PVC glue or solvent dispenser 40. PVC glue or solvent dispenser 40 is a tube with a plurality of holes between the inner portion of the tube and the outer surface of the tube. As pressure is applied to reservoir 14 through pushing rod 14 and sealing component 28, PVC primer (solvent) or PVC glue contained in reservoir 14, will flow through the interior of receiving tube 34 and through the plurality of holes 40 to foam applicator 24 saturating foam applicator 24. When one end of union 22 (not shown in FIG. 3) is pressed down over foam applicator 24, PVC primer (solvent) or PVC glue is applied to the inner surface of union 22 from foam applicator 24. When porous foam applicator housing 12 is removed from reservoir 14, a flexible cap (not shown) is placed over the end of receiving tube 34 to prevent the loss of PVC primer (solvent) or PVC glue from foam applicator housing 12 and a flexible plug (not shown) is inserted into the hole in the end of reservoir 14 to prevent the loss of PVC primer (solvent) or PVC glue from reservoir 14.

Now referencing FIG. 4 where 60 depicts a cut away view of porous foam applicator housing 12. In this depiction, foam applicator 26 sits on PVC glue or solvent dispenser 36. PVC glue or solvent dispenser 36 is a support plate with a plurality of holes between the cavity 28 and foam applicator 26. As pressure is applied to reservoir 14 through pushing rod 16 and sealing component 28, PVC primer (solvent) or PVC glue contained in reservoir 14, will flow through the interior of receiving tube 34 into cavity 38, through the plurality of holes 42 to foam applicator 26 saturating foam applicator 26. When one end of pipe 20 (not shown in FIG. 4) is pressed into the center hole in foam applicator 26, PVC primer (solvent) or PVC glue is applied to the outer surface of pipe 20 from foam applicator 26. When porous foam applicator housing 12 is removed from reservoir 14, a flexible cap (not shown) is placed over the end of receiving tube 34 to prevent the loss of PVC primer (solvent) or PVC glue from foam applicator housing 12 and a flexible plug (not shown) is inserted into the hole in the end of reservoir 14 to prevent the loss of PVC primer (solvent) or PVC glue from reservoir 14.

The inventor intends that only those claims which use the words “means for” are intended to be interpreted under 35 USC 112, sixth paragraph. Moreover, no limitations from the specification are intended to be read into any claims, unless those limitations are expressly included in the claims.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.
a. The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A system to facilitate the application of PVC primer (solvent) or PVC glue to the interior of PVC unions without over or under application of the PVC primer (solvent) or PVC glue thus facilitating a more perfect joining of the PVC pipe and PVC union comprising:
a. a reservoir tube in which said PVC primer (solvent) or PVC glue resides,
b. said reservoir tube is capped on one end with a cap containing a hole in the center through which said PVC primer (solvent) or PVC glue flows under pressure into a handheld porous foam applicator housing, and
c. said reservoir tube is communicably coupled to said handheld porous foam applicator housing through a receiving tube in the bottom of said handheld porous foam applicator housing, and
d. the opposite end of said reservoir tube contains a threaded cap containing a hole, said threaded cap is held onto said reservoir tube with a set of threads on said reservoir tube, and
e. said threaded cap retains a pushing rod attached to a sealing component assembly within said reservoir tube, said sealing component assembly within said reservoir tube contains a plurality of “O” rings to seal said reservoir from leaking said PVC primer (solvent) or PVC glue past said sealing component assembly, and
f. said sealing component assembly pressurizes said reservoir tube when a user pushes said pushing rod which pushes said sealing component assembly into the interior of said reservoir tube, and
g. when said reservoir tube is pressurized, said PVC primer (solvent) or PVC glue flows through said hole in said cap into said receiving tube in the bottom of said handheld porous foam applicator housing, and
h. said receiving tube extends up into a porous foam plug whose height is the same as the depth of a gluing area in a PVC union, and
i. said receiving tube contains a plurality of holes through which said PVC primer (solvent) or PVC glue, under pressure, flows into said porous foam plug saturating said porous foam plug, and
j. said user inserts said PVC union into said handheld porous foam applicator housing and onto said porous foam plug thus applying said PVC primer (solvent) or PVC glue from the outer surface of said porous foam plug onto the inner surface of said PVC union.

2. Method for facilitating a user applying PVC primer (solvent) or PVC glue to the interior of PVC unions without over or under application of said PVC primer (solvent) or PVC glue thus facilitating a more perfect joining of a PVC pipe and said PVC union comprising:
a. a handheld removable porous foam applicator housing containing a porous foam plug is filled with PVC primer (solvent) or PVC glue from a manually pressurized reservoir tube containing said PVC primer (solvent) or PVC glue through a receiving tube fixed to the bottom of said handheld removable porous foam applicator housing and communicable coupled to said manually pressurized reservoir tube through a hole in a cap sealing the end of said manually pressurized reservoir tube;
b. removing said handheld removable porous foam applicator housing once said handheld removable porous foam applicator housing is filled with said PVC primer (solvent) or PVC glue from said manually pressurized reservoir tube;
c. insertion of a PVC union by a user onto said porous foam plug, the diameter of said porous foam plug residing in said handheld removable porous foam applicator housing is the same dimension as the inside diameter of said PVC union;
d. twisting of said handheld removable porous foam applicator housing to facilitate the application of PVC primer (solvent) or PVC glue from the outside surface of said porous foam plug to the inside surface of said PVC union;
e. removing of said PVC union from said handheld porous foam applicator housing.

3. Any of the methods of claim 2 where once said handheld porous foam applicator housing is removed from said manually pressurized reservoir containing said PVC primer (solvent) or PVC glue a flexible cap is placed over the end of said receiving tube fixed to the bottom of said handheld porous foam applicator housing to prevent loss of said PVC primer (solvent) or PVC glue from said handheld foam applicator housing and a flexible plug is inserted into the hole in said cap sealing the end of said manually pressurized reservoir tube to prevent loss of PVC primer (solvent) or PVC glue from said manually pressurized reservoir tube.

4. A system to facilitate the application of PVC primer (solvent) or PVC glue to the exterior of PVC pipes without over or under application of the PVC primer (solvent) or PVC glue thus facilitating a more perfect joining of the PVC pipe and PVC union comprising:
a. a reservoir tube in which said PVC primer (solvent) or PVC glue resides;
b. said reservoir tube is capped on one end with a cap containing a hole in the center through which said PVC primer (solvent) or PVC glue flows under pressure into a handheld porous foam applicator housing, and
c. said reservoir tube is communicably coupled to said handheld porous foam applicator housing through a receiving tube in the bottom of said foam applicator housing, and
d. the opposite end of said reservoir tube contains a threaded cap containing a hole, said threaded cap is held onto said reservoir tube with a set of threads on said reservoir tube, and
e. said threaded cap retains a pushing rod attached to a sealing component assembly within said reservoir tube, said sealing component assembly within said reservoir tube contains a plurality of “O” rings to seal said reservoir from leaking said PVC primer (solvent) or PVC glue past said sealing component assembly, and
f. said sealing component assembly pressurizes said reservoir tube when a user pushes said pushing rod which pushes said sealing component assembly into the interior of said reservoir tube, and
g. when said reservoir tube is pressurized, said PVC primer (solvent) or PVC glue flows through said hole in said cap into said receiving tube in the bottom of said handheld porous foam applicator housing, and
h. said PVC primer (solvent) or PVC glue flows into a receiving space between the bottom of said handheld porous foam applicator housing and said porous foam plug retaining plate, said porous foam retaining plate contains a plurality of holes through which said PVC primer (solvent) or PVC glue flows from said receiving space into said foam plug retaining plate, and
i. said porous foam plug contains a hole in the center which receives a PVC pipe inserted by said user, said hole in the center of said foam plug is the same diameter as the outside diameter of said PVC pipe inserted by said user into said hole in the center of said foam plug, and
j. said PVC primer (solvent) or PVC glue is applied from the inner surface of said hole in said porous foam plug onto said outer surface of said PVC pipe.

5. Method for facilitating a user applying PVC primer (solvent) or PVC glue to the exterior of a PVC pipe without over or under application of said PVC primer (solvent) or PVC glue thus facilitating a more perfect joining of said PVC pipe and a PVC union comprising:
a. a handheld removable porous foam applicator housing containing a porous foam plug is filled with PVC primer (solvent) or PVC glue from a manually pressurized reservoir tube containing said PVC primer (solvent) or PVC glue through a receiving tube fixed to the bottom of said handheld removable porous foam applicator housing and communicable coupled to said manually pressurized reservoir tube through a hole in a cap sealing the end of said manually pressurized reservoir tube;
b. removing said handheld removable porous foam applicator housing once said handheld removable porous foam applicator housing is filled with said PVC primer (solvent) or PVC glue from said manually pressurized reservoir tube;
c. insertion of a said PVC pipe by a user into a hole in the middle of said porous foam plug, the diameter of said hole in said porous foam plug residing in said handheld removable porous foam applicator housing is the same dimension as the outside diameter of said PVC pipe;
d. twisting of said removable porous foam applicator housing to facilitate the application of said PVC primer (solvent) or PVC glue from the inside surface of said porous foam plug to the outside surface of said PVC pipe;
e. removing of said PVC pipe from said porous foam applicator housing.

6. Any of the methods of claim 5 where once said handheld porous foam applicator housing is removed from said manually pressurized reservoir containing said PVC primer (solvent) or PVC glue a flexible cap is placed over the end of said receiving tube fixed to the bottom of said handheld porous foam applicator housing to prevent loss of said PVC primer (solvent) or PVC glue from said handheld foam applicator housing and a flexible plug is inserted into said hole in said cap sealing the end of said manually pressurized reservoir tube to prevent loss of said PVC primer (solvent) or PVC glue from said manually pressurized reservoir tube.
